(19) United States
(12) Patent Application Publication
(10) Pub. No.: US 2015/0140906 A1
(43) Pub. Date: May 21, 2015

(54) CLEANING AGENT FOR ALLOY MATERIAL, AND METHOD FOR PRODUCING ALLOY MATERIAL

(71) Applicant: FUJIMI INCORPORATED, Kiyosu-shi, Aichi (JP)

(72) Inventors: Hitoshi Morinaga, Kiyosu-shi (JP); Maiko Asai, Kiyosu-shi (JP); Yuuichi Ito, Kiyosu-shi (JP)

(73) Assignee: FUJIMI INCORPORATED, Kiyosu-shi, Aichi (JP)

(21) Appl. No.: 14/395,988

(22) PCT Filed: Apr. 24, 2013
(86) PCT No.: PCT/JP2013/062074

§ 371 Date: Oct. 21, 2014

(30) Foreign Application Priority Data
Apr. 27, 2012 (JP) 2012-103252

(51) Int. Cl. C11D 11/00; C11D 1/22

(52) U.S. Cl. CPC C11D 11/0029; C11D 1/22
USPC 451/54; 562/91; 510/274

(57) ABSTRACT

A cleaning agent for an alloy material is provided. The cleaning agent has a pH in a range between 1.5 and 4, inclusive, and contains an anionic surfactant having an SO₃M group (where M represents a counter ion). It is preferable that the cleaning agent for an alloy material further contains an organic acid. A method for producing an alloy material is also provided. The method includes a step for cleaning the alloy material using the cleaning agent for an alloy material.

### TECHNICAL FIELD

The present invention relates to a cleaning agent for alloy material and a method for producing an alloy material.

### BACKGROUND ART

Alloy materials are used in various applications because of their advantage of having better properties such as mechanical strength, chemical resistance, corrosion resistance, or heat resistance than those of pure metal materials. Alloy materials are subjected to processing such as polishing (see Patent Documents 1 and 2). The alloy materials applied to applications requiring cleanliness are cleaned using a cleaning liquid.

### PRIOR ART DOCUMENTS

### Patent Documents

### Patent Document 1: Japanese Laid-Open Patent Publication No. 01-246068

### Patent Document 2: Japanese Laid-Open Patent Publication No. 11-010492

### SUMMARY OF THE INVENTION

### Problems that the Invention is to Solve

Cleaning agents for alloy material applied to alloy materials still have room for improvement in view of removal of foreign matters attached to the alloy material surface and suppression of corrosion of the alloy material surface. For instance, if the cleaning agent for alloy material is improved in the performance of removal of foreign matters attached to an alloy material surface, the alloy material surface may be more easily corroded.

An objective of the present invention is to provide a cleaning agent for alloy material and a method for producing an alloy material capable of attaining high cleanliness of an alloy material surface and suppressing deterioration in quality due to corrosion of the alloy material surface.

### Means for Solving the Problems

To achieve the foregoing objective and in accordance with one aspect of the present invention, a cleaning agent for alloy material is provided that includes an anionic surfactant having an SO₃M group (where M represents a counter ion) and has a pH in a range between 1.5 and 4, inclusive.

The cleaning agent for alloy material preferably further includes an organic acid.

In accordance with another aspect of the present invention, a method for producing an alloy material is provided that includes a cleaning step for cleaning an alloy material using the above described cleaning agent for alloy material.

The cleaning agent for alloy material preferably has a temperature of 60° C. or below in the cleaning step.

The method for producing an alloy material preferably further includes a polishing step performed prior to the cleaning step, and the alloy material is preferably polished using a polishing composition in the polishing step.

In the cleaning step, the alloy material and the cleaning agent for alloy material are preferably brought into contact with each other before the polishing composition attached to the alloy material in the polishing step is dried.

### Effects of the Invention

According to the present invention, high cleanliness of an alloy material surface is obtained and deterioration in quality due to corrosion of the alloy material surface is suppressed.

### MODES FOR CARRYING OUT THE INVENTION

Hereinafter, one embodiment according to the present invention will be described.

A cleaning agent for alloy material contains an anionic surfactant and has a pH in a range between 1.5 and 4, inclusive. At least a part of a surface of an alloy material to which the cleaning agent for alloy material according to the present embodiment is applied is composed of a mirror surface having been polished using a polishing composition.

The anionic surfactant used in the cleaning agent for alloy material has an SO₃M group (where M represents a counter ion). Hereinafter, the term “anionic surfactant” refers to an anionic surfactant having the SO₃M group unless otherwise specified.

Specific examples of the anionic surfactant include, for example, alkyl sulfonic acid compounds, alkyl benzene sulfonic acid compounds, alkyl naphthalene sulfonic acid compounds, methyltaurine compounds, alkyl diphenyl ether disulfonic acid compounds, α-olefin sulfonic acid compounds, naphthalene sulfonic acid condensates and sulfosuccinic acid diester compounds. A polymer or a copolymer having an SO₃M group as a side chain or the like may be also used as the anionic surfactant. Specific examples of the counter ion represented by “M” in the SO₃M group include a hydrogen ion, an alkali metal ion, an ammonium ion, and an alkanolamine ion. Specific examples of the alkali metal ion include, for example, a lithium ion, a sodium ion and a potassium ion.

Among the anionic surfactants, alkyl benzene sulfonic acids or salts thereof are preferred in view of high cleaning performance and low corrosiveness to the alloy material. The carbon number of the alkyl group in the alkyl benzene sulfonic acids is preferably from 8 to 20, and more preferably from 10 to 15. Dodecyl benzene sulfonic acid or a salt thereof, for example, is suitably used as the alkyl benzene sulfonic acid or salt thereof, respectively.

When the anionic surfactant of sulfonic acid type in which the counter ion represented by “M” in the SO₃M group is a hydrogen ion is used among the anionic surfactants, the pH of the cleaning agent for alloy material can be lowered. Therefore, the pH of the cleaning agent for alloy material can be easily adjusted to 4 or less.

The anionic surfactant content in the cleaning agent for alloy material is preferably 170 ppm by mass (170 mg/kg) or more, and more preferably 300 ppm by mass (300 mg/kg) or more. The more the anionic surfactant content in the cleaning agent for alloy material, the higher the cleaning performance becomes. The anionic surfactant content in the cleaning agent for alloy material is preferably 15000 ppm by mass (15000 mg/kg) or less, more preferably 5000 ppm by mass (5000 mg/kg) or less, and further preferably 2000 ppm by mass (2000 mg/kg) or less. The less the anionic surfactant content in the cleaning agent for alloy material, the cleaning agent becomes less corrosive to the alloy material.

The cleaning agent for alloy material may also contain an anionic surfactant other than the above-described anionic surfactants, a nonionic surfactant, a water-soluble polymer, a chelating agent and the like for the purpose of, for example, improving the cleaning performance or controlling foaming. Specific examples of the anionic surfactant other than the above-described anionic surfactants include, for example, polycarboxylic acid surfactants and alkyl benzene sulfate ester surfactants. Specific examples of the nonionic surfactant include, for example, polyoxyethylene alkyl ethers, sorbitan monooleate and oxyalkylene-based polymers having one or more types of oxyalkylene units. Specific examples of the water-soluble polymer include, for example, polyethylene glycol, polyvinyl alcohol, polyvinyl pyrrolidone, and hydroxyethyl cellulose. Specific examples of the chelating agent include, for example, amines, amino acids, organic phosphonic acids, phenol derivatives, polyamino phosphonic acids, and 1,3-diketones.

The cleaning agent for alloy material may also contain an anticorrosive in view of suppressing alloy material corrosion. The anticorrosive is not particularly limited, but is preferably a heterocyclic compound. In the heterocyclic compound, the number of ring members of the heterocyclic ring is not particularly limited. The heterocyclic compound may be a monocyclic compound or a polycyclic compound having a condensed ring.

The cleaning agent for alloy material may also contain an antifoaming agent in view of suppressing foaming caused by, for example, the anionic surfactant. Specific examples of the antifoaming agent include, for example, silicone oil-based antifoaming agents and mineral oil-based antifoaming agents.

When the cleaning agent for alloy material is applied to an alloy material that has been polished using a polishing composition containing colloidal silica as abrasive grains, the pH of the cleaning agent for alloy material is preferably between 1.6 and 3.5, inclusive.

The cleaning agent for alloy material may contain a known acid, base, or salt as a pH adjuster. Specific examples of the acid include inorganic acids and organic acids. Specific examples of the inorganic acids include, for example, hydrochloric acid, sulfuric acid, nitric acid, hydrofluoric acid, boric acid, carbonic acid, hypophosphorous acid, phosphorous acid, and phosphoric acid. Specific examples of the organic acids include, for example, formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, phenoxyacetic acid, hydroxyethylidenediphosphonic acid, nitrilotris (methylenephosphonic acid), phosphonobutanetricarboxylic acid, and ethylenediaminetetra(methylenephosphonic acid). The pH adjuster is preferably an organic acid, more preferably at least one selected from glycolic acid, succinic acid, maleic acid, citric acid, tartaric acid, malic acid, gluconic acid, and itaconic acid, and most preferably citric acid.

Specific examples of the base include, for example, organic bases such as amines and quaternary ammonium hydroxides, hydroxides of alkali metals, hydroxides of alkaline earth metals, and ammonia. Specific examples of the salt include, for example, ammonium salts of acids and alkali metal salts of acids. The pH adjusters may be used singly or in combination of two or more. For example, combination of a weak acid and a strong base, a strong acid and a weak base, or a weak acid and a weak base exerts a buffering effect on pH.

Specific examples of the alloy material to which the cleaning agent for alloy material is applied include, for example, aluminum alloys, titanium alloys, magnesium alloys, stainless steels, nickel alloys, and copper alloys. As the aluminum alloys, those containing from 0.1 to 10% by mass of one or more of silicon, iron, copper, manganese, magnesium, zinc, chromium and the like in aluminum as specified in, for example, Japanese Industrial Standard (JIS) H4000:2006 or ISO 209:1989, are preferred. As the titanium alloys, those containing from 3.5 to 30% by mass of one or more of aluminum, iron, vanadium and the like in titanium as specified in, for example, JIS H4600:2007, are preferred. As the stainless steels, those containing from 10 to 50% by mass of one or more of chromium, nickel, molybdenum, manganese and the like in iron as specified in, for example, JIS G4303:2005, are preferred. As the nickel alloys, those containing from 20 to 75% by mass of one or more of iron, chromium, molybdenum, cobalt and the like in nickel as specified in, for example, JIS H4551:2000, are preferred. As the copper alloys, those containing from 3 to 50% by mass of one or more of iron, lead, zinc, tin and the like in copper as specified in, for example, JIS H3100:2006, are preferred. Preferably, the cleaning agent for alloy material according to the present invention is mainly applied to alloy materials, but can be also applied to pure metal materials such as aluminum, titanium, iron, nickel, or copper.

The cleaning agent for alloy material contains water as a solvent or a dispersion medium. It is preferable to use water having a low impurity content, e.g., deionized water, pure water, super-pure water, or distilled water.

The cleaning agent for alloy material may also contain a rust inhibitor, an alcohol compatible with water or the like in addition to the above ingredients as necessary.

A method for producing an alloy material will now be described along with operation of the cleaning agent for alloy material.

The method for producing an alloy material includes a polishing step for polishing an alloy material and a cleaning step for cleaning the alloy material.

In the polishing step, at least a part of the alloy material surface is polished using a polishing composition. Through the polishing step, at least a part of the alloy material surface is mirror finished. The polishing composition contains abrasive grains, which physically polish the alloy material surface. The kind of the abrasive grains can be suitably changed according to the kind of the alloy material. Examples of the material of the abrasive grains include silicon oxide, aluminum oxide, cerium oxide, zirconium oxide, titanium oxide, manganese oxide, silicon carbide, and silicon nitride. A single type of abrasive grains may be used. Alternatively, two or more types of abrasive grains may be used in combination.

The average particle size of the abrasive grains is, for example, in a range between 5 nm and 400 nm. The average particle size of the abrasive grains is calculated from the measured value of the specific surface area by the nitrogen adsorption method (BET method).

Among materials for abrasive grains, silicon oxide or aluminum oxide is preferred, and silicon oxide is particularly preferred in view of increasing the polishing rate. Specific examples of the abrasive grains (particles) formed of silicon oxide include, for example, colloidal silica, fumed silica, and sol-gel silica. Among the abrasive grains formed of silicon oxide, colloidal silica is preferred.

The pH of the polishing composition is adjusted, for example, in a range between 1 and 12, inclusive. The pH of the polishing composition can be adjusted using any of the pH adjusters as described above for the cleaning agent for alloy material. When colloidal silica is employed as the abrasive grains, the pH of the polishing composition is preferably adjusted in a range between 8 and 12, inclusive, in view of maintaining the dispersibility of the colloidal silica. When surface-modified colloidal silica is employed, the pH of the polishing composition can also be adjusted within the acidic region (e.g., pH in a range between 0.5 or and 4.5, inclusive).

The polishing composition may contain an oxidizing agent that chemically polishes the alloy material surface. Specific examples of the oxidizing agent include, for example, hydrogen peroxide, peracetic acid, percarbonates, urea peroxide, perchloric acid, perchlorates, persulfates, periodates, and permanganates. Among the oxidizing agents, at least one of hydrogen peroxide and persulfates is preferred in view of the polishing rate. Specific examples of the persulfates include, for example, sodium persulfate, potassium persulfate, and ammonium persulfate. Among the oxidizing agents, hydrogen peroxide is most preferred because of high stability in water and a low environmental load.

The polishing composition contains water as a solvent or a dispersion medium. It is preferable to use water having a low impurity content, e.g., deionized water, pure water, super-pure water, or distilled water. The polishing composition may also contain an anionic surfactant, a nonionic surfactant, a chelating agent, a rust inhibitor, a preservative, an antifungal agent or the like as necessary.

In the polishing step, a polishing apparatus for polishing metal can be used. Specific examples of the polishing apparatus include a single-side polishing apparatus and a double-side polishing apparatus. In the polishing step, a polishing pad is pressed against the alloy material surface and the alloy material or the polishing pad is rotated, while supplying a polishing composition to the alloy material surface. Then, the alloy material is physically polished by the friction between the polishing pad and the alloy material and between the polishing composition and the alloy material. When the polishing composition containing an oxidizing agent or the polishing composition having a pH modifying the alloy material surface is used, the alloy material is also chemically polished.

Specific examples of the polishing pad include those of polyurethane type, nonwoven fabric type, and suede type. The polishing pad may contain abrasive grains. Alternatively, the polishing pad may contain no abrasive grains. Among the polishing pads, that of the suede type not containing abrasive grains is suitably used.

In the cleaning step, the alloy material, which has been polished, is cleaned using the cleaning agent for alloy material. The cleaning step includes a first cleaning stage, where the alloy material and the cleaning agent for alloy material are brought into contact with each other, and a second cleaning stage, where the cleaning agent for alloy material is removed from the alloy material surface. In the first cleaning stage, the alloy material is first immersed in the cleaning agent for alloy material before the polishing composition having attached to the alloy material in the polishing step is dried. Thus, the alloy material surface is prevented from being dried, thereby sticking of foreign matters such as the abrasive grains to the alloy material surface is suppressed. Since the surface of the alloy material immersed in the cleaning agent for alloy material is protected by the cleaning agent for alloy material, contact of the alloy material surface with, for example, an oxidative gas is suppressed.

In the first cleaning stage, the cleaning agent for alloy material, in which the alloy material is immersed, is then exposed to an ultrasonic wave. Foreign matters attached to the alloy material are effectively removed with the energy caused by generation of bubbles by the ultrasonic wave and rupture thereof. When the force, the frequency and the exposure time of the ultrasonic wave are adjusted according to the alloy material, cleaning efficiency can be improved without damaging the alloy material. The exposure is typically performed with the ultrasonic wave having a frequency of from 20 kHz to 2000 kHz. The frequency is preferably from 200 kHz to 1000 kHz. The higher the frequency, the better the alloy material is prevented from being damaged. The lower the frequency, generally, the higher the cleaning efficiency becomes.

Since the cleaning agent for alloy material used in the first cleaning stage contains anionic surfactant and has a pH of 4 or less, foreign matters such as abrasive grains are easily removed from the alloy material surface. In addition, since the cleaning agent for alloy material has a pH of 1.5 or more, corrosion of the alloy material surface is easily suppressed.

The first cleaning stage may be performed in the state where the alloy material is either placed at a predetermined position in a stationary state or being moved. The temperature of the cleaning agent for alloy material in the first cleaning stage is preferably 60° C. or below, and more preferably 55° C. or below in view of suppressing corrosion of the alloy material. The temperature of the cleaning agent for alloy material in the first cleaning stage is, for example, preferably 1° C. or above, more preferably 10° C. or above, and still more preferably 20° C. or above. The higher the temperature of the cleaning agent for alloy material in the first cleaning stage, the higher the cleaning effect becomes.

In the second cleaning stage, the alloy material taken out of the cleaning agent for alloy material is immersed in water, and then the water in which the alloy material is immersed is exposed to the ultrasonic wave described above to diffuse the cleaning agent for alloy material attached to the alloy material into the water. Thus, the cleaning agent for alloy material is removed from the alloy material surface. In the second cleaning stage, when foreign matters that have not been removed in the first cleaning stage remain on the alloy material surface, the foreign matters are diffused into the water together with the cleaning agent for alloy material.

The water used in the second cleaning stage is preferably water having a low impurity content, e.g., deionized water, pure water, super-pure water, or distilled water.

The alloy material, which has been cleaned in the cleaning stop is naturally dried or forcibly dried by, for example, blowing dry air. The alloy material is machined as necessary to be used in various applications, for example, construction materials such as containers and building materials, and transport equipment such as automobiles, ships and aircrafts, as well as various electric appliances and electronic components.

According to the embodiment described above, the following advantages are achieved.

(1) The cleaning agent for alloy material contains an anionic surfactant having an SO₃M group and has a pH in a range between 1.5 and 4, inclusive. Therefore, foreign matters attached to the alloy material surface are easily removed and corrosion of the alloy material surface is suppressed. Accordingly, a cleaning agent for alloy material is provided that is capable of increasing the cleanliness of the alloy material surface and suppressing deterioration in quality due to corrosion of the alloy material surface.

(2) The cleaning agent for alloy material preferably contains an organic acid. In this case, the pH of the cleaning agent for alloy material is easily adjusted within the above pH range and the effects based on the pH are more increased.

(3) It is preferable to use an anionic surfactant of sulfonic acid type in which the counter ion represented by “M” in the SO₃M group is a hydrogen ion among the anionic surfactants. In this case, the pH of the cleaning agent for alloy material can be easily adjusted to 4 or less.

(4) The method for producing an alloy material contains the cleaning step of cleaning the alloy material using the cleaning agent for alloy material. According to the production method, an alloy material can be easily obtained in which the cleanliness of the surface is improved and defects due to surface corrosion are reduced.

(5) The temperature of the cleaning agent for alloy material in the cleaning step is preferably 60° C. or below. In this case, corrosion of the alloy material surface is further easily suppressed.

(6) The cleaning step is preferably performed after the polishing step in which the alloy material is polished using a polishing composition. In this case, the polishing composition having attached to the alloy material in the polishing step can be easily removed. When, for example, an aluminum alloy is polished using a polishing composition containing abrasive grains such as colloidal silica, and then the alloy is cleaned using the cleaning agent for alloy material according to the present embodiment, foreign matters such as abrasive grains can be easily cleaned away.

(7) In the cleaning step, the alloy material and the cleaning agent for alloy material are preferably brought into contact with each other before the polishing composition having attached to the alloy material in the polishing step is dried. In this case, the alloy material surface is prevented from being dried during the period from the end of the polishing step to the beginning of the cleaning step. Thus, the sticking of the ingredients in the polishing composition to the alloy material surface is suppressed. Therefore, cleanliness of the alloy material surface can be more improved. Since the alloy material surface in contact with the cleaning agent for alloy material is protected by the cleaning agent for alloy material, corrosion of the alloy material surface is suppressed. Particularly, it is preferable to bring the alloy material and the cleaning agent for alloy material into contact with each other by immersing the alloy material into the cleaning agent for alloy material.

(8) A mirror surface formed by polishing is advantageous in that the mirror surface is better in durability than that formed by, for example, plating or coating. Particularly, the mirror surface formed by polishing using a polishing composition has higher flatness, thereby being advantageous in that the alloy material having the more highly accurate mirror surface can be obtained. In such an alloy material having the highly accurate mirror surface, deterioration of cleanliness and corrosion of the mirror surface are visually recognized easily. Therefore, higher cleaning performance and lower corrosiveness are required for the cleaning agent for alloy material applied to such an alloy material having a highly accurate mirror surface. The cleaning agent for alloy material according to the present embodiment is particularly advantageous in that the cleaning agent for alloy material can improve the cleanliness of the mirror surface having been polished using the polishing composition, while maintaining high flatness of the mirror surface.

The embodiment described above may be modified as follows.
The first cleaning stage may be performed in a manner in which the cleaning agent for alloy material is circulated in the state where the alloy material is immersed in the cleaning agent for alloy material in the cleaning vessel. In the first cleaning stage, the circulation of the cleaning agent for alloy material may be used in combination with the ultrasonic wave exposure described above.
The ultrasonic wave exposure in the first cleaning stage may be omitted.
In the first cleaning stage, the alloy material and the cleaning agent for alloy material may be brought into contact with each other by spraying the cleaning agent for alloy material to the alloy material surface or pouring the cleaning agent for alloy material over the alloy material surface.
As the preliminary stage for the first cleaning stage, the alloy material may be pre-cleaned with a cleaning agent other than the cleaning agent for alloy material described above.
The first cleaning stage may be performed after the polishing composition having attached to the alloy material in the polishing step is dried.
The second cleaning stage may be performed in a manner in which water is circulated in the state where the alloy material is immersed in the water in the cleaning vessel. In the second cleaning stage, the circulation of the water may be used in combination with the ultrasonic wave exposure described above.
The second cleaning stage may be performed by means of spraying water to the alloy material surface or pouring water over the alloy material surface.
In the cleaning step, scrub cleaning using, for example, a PVA sponge, a nonwoven fabric or a nylon brush may be carried out. The cleaning step may be performed using a polishing apparatus. That is, in the cleaning step, the alloy material may be scrub-cleaned with a polishing pad, while pouring the cleaning agent for alloy material or water over the alloy material.
The water used in the second cleaning stage may be changed to an organic solvent such as an alcohol, a mixed solvent of water and an alcohol or the like, a liquid containing an ingredient such as a rust inhibitor, or the like.
The first cleaning stage or the second cleaning stage may be repeated a number of times.
In the cleaning step, the surface to be cleaned may be the entire surface of the alloy material or a part of the alloy material surface.
The shape of the alloy material is not particularly limited. The alloy material may have a surface of any shape including, for example, a flat surface, a curved surface such as a convex or concave surface, and a spherical surface.
The alloy material may have the mirror surface over its entire surface or over a part of the surface.
The alloy material may be, for example, a plate-like body having the mirror surfaces on both sides or that having the mirror surface on a single side only.
The cleaning agent for alloy material may be applied to an alloy material having no mirror surface. That is, the alloy material to be cleaned may be also an alloy material that has been subjected to the polishing step and has a surface other than the mirror surface. Furthermore, the alloy material to be cleaned is not limited to an alloy material that has been subjected to the polishing step, but the alloy material to be cleaned may be also a cut alloy material, for example. Even in this case, when the cleaning agent for alloy material is used, foreign matters attached to the alloy material surface are easily removed and the deterioration in quality due to the corrosion of the alloy material surface can be suppressed.
Plating or coating may be applied to the alloy material after being cleaned with the cleaning agent for alloy material. In the case of the alloy material having a mirror surface, however, the mirror surface is preferably left exposed in view of an appearance or durability.
The cleaning agent for alloy material may be prepared by diluting an undiluted solution of the cleaning agent for alloy material with, for example, water.
The cleaning agent for alloy material that has been once used for cleaning the alloy material can be recovered and reused for cleaning again. For example, solid matter contained in the used cleaning agent for alloy material recovered from the cleaning vessel may be removed by filtration or the like, and then the cleaning agent can be reused. An unused cleaning agent for alloy material may be supplied to the cleaning vessel together with the used cleaning agent for alloy material as necessary. Reuse of the cleaning agent for alloy material is advantageous in that the environmental load can be reduced through decreasing the amount of the cleaning agent for alloy material to become waste fluid and in that the costs required for cleaning can be reduced through decreasing the amount of the cleaning agent for alloy material used.

The technical ideas obtainable from the above embodiment will hereafter be described.

(a) A cleaning agent for alloy material containing, as the anionic surfactant described above, an anionic surfactant of sulfonic acid type in which the counter ion represented by “M” in the SO₃M group is a hydrogen ion.

(b) A cleaning agent for alloy material containing an anionic surfactant having an SO₃M group (where M represents a counter ion) and having a pH in a range between 1.5 and 4, inclusive, the cleaning agent for alloy material being applied to the alloy material having been polished using a polishing composition, the polishing composition containing colloidal silica and an oxidizing agent and having a pH in a range between 8 and 12, inclusive.

(c) A cleaning agent for alloy material applied to the alloy material having a mirror surface having been polished using a polishing composition, the cleaning agent for alloy material being used in the application for cleaning the mirror surface thereof.

### EXAMPLES

Then, Examples and Comparative Examples will be described.

The cleaning agents for alloy material having compositions 1 to 10 shown in Table 1 were prepared, respectively. For the cleaning agents for alloy material having the compositions 1 to 3, 5 to 7, and 9, the anionic surfactant was first diluted with water, and then a pH adjuster was added thereto. The pH of each cleaning agent for alloy material is as shown in the column “pH” in Table 1. The pH was measured for each cleaning agent for alloy material at 20° C.

An alloy material was produced using each cleaning agent for alloy material having each of the compositions 1 to 10. As shown in Table 2, the cleaning agents for alloy material having the compositions 1 to 7 were used in Examples 1 to 7, respectively, and the cleaning agents for alloy material having the compositions 8 to 10 were used in Comparative Examples 1 to 3, respectively.

In Example 1, a plate-like aluminum alloy of 32 mm×32 mm×5 mm in size was used as an alloy material. This aluminum alloy contains about 1% of Si, Fe, Mn and the like in total.

First, a polishing step of polishing the alloy material was performed using a polishing composition containing colloidal silica as abrasive grains and having a pH of 10. In this polishing step, the alloy material was polished using a polishing pad of suede type not containing abrasive grains until one surface of the alloy material became a mirror surface, while applying a constant pressure.

Then, the first cleaning stage was performed as follows. The alloy material after the polishing step was immersed in the cleaning agent for alloy material having the composition 1 in a first cleaning vessel. The first cleaning vessel was transported to a second cleaning vessel equipped with an ultrasonic generator. The alloy material was transferred into the second cleaning vessel and was immersed in the cleaning agent for alloy material having the composition 1 in the second cleaning vessel. Then, the temperature of the cleaning agent for alloy material in the second cleaning vessel was elevated up to the temperature shown in the column “Cleaning temperature” in Table 2 and the cleaning agent for alloy material was exposed to an ultrasonic wave having a frequency of 750 kHz for 3 minutes, while maintaining the above-described temperature of the cleaning agent for alloy material. The temperature of the cleaning agent for alloy material did not exceed the temperature shown in the column “Cleaning temperature” in Table 2 throughout the first cleaning stage.

Then, the second cleaning stage was performed as follows. The alloy material was transferred into a third cleaning vessel and immersed in pure water in the third cleaning vessel. Subsequently, the pure water in the third cleaning vessel was exposed to an ultrasonic wave having a frequency of 430 kHz for 3 minutes.

Finally, the alloy material was taken out of the third cleaning vessel and was dried by blowing dry air.

In Examples 2 to 7 and Comparative Examples 1 to 3, the alloy material was polished, cleaned, and dried in the same manner as in Example 1 except that the cleaning agent for alloy material was changed as shown in Table 2.

### <Evaluation for Cleanliness>

While directing a spotlight on the surface of the alloy material obtained in each Example or Comparative Example in a dark room, the level of the residual polishing composition on the alloy material surface was checked by visual observation. In the column “Cleanliness” in Table 2, “A” indicates a state where the residual polishing composition was not visually recognized over the entire mirror surface of the alloy material, “B” indicates a state where the residual polishing composition in a slight level was visually recognized on the mirror surface of the alloy material, and “C” indicates a state where the residual polishing composition was visually recognized over the entire mirror surface of the alloy material.

### <Evaluation for Corrosion Suppression>

The corrosion level on the mirror surface of the alloy material obtained in each Example or Comparative Example was checked by visual observation using a differential interference microscope. In the column “Corrosion suppression” in Table 2, “A” indicates a state where the corrosion was not visually recognized over the entire mirror surface of the alloy material, “B” indicates a state where the corrosion in a slight level was visually recognized on the mirror surface of the alloy material, and “C” indicates a state where the corrosion was visually recognized over ½ or more of the mirror surface of the alloy material.

TABLE 1

| | Anionic surfactant | | pH adjuster | | |
|---|---|---|---|---|---|
| | | Content | | Content | |
| | | [ppm by | | [% by | |
| | Kind | mass] | Kind | mass] | pH |
| Composition 1 | Dodecyl benzene | 300 | Citric | 0.1 | 2.65 |
| | sulfonic acid | | acid | | |
| Composition 2 | Dodecyl benzene | 500 | Citric | 0.1 | 2.68 |
| | sulfonic acid | | acid | | |
| Composition 3 | Dodecyl benzene | 1000 | Citric | 0.1 | 2.61 |
| | sulfonic acid | | acid | | |
| Composition 4 | Dodecyl benzene | 500 | — | — | 2.90 |
| | sulfonic acid | | | | |
| Composition 5 | Dodecyl benzene | 300 | Citric | 0.2 | 2.15 |
| | sulfonic acid | | acid | | |
| Composition 6 | Dodecyl benzene | 500 | Citric | 0.2 | 2.15 |
| | sulfonic acid | | acid | | |
| Composition 7 | Dodecyl benzene | 1000 | Citric | 0.2 | 2.10 |
| | sulfonic acid | | acid | | |
| Composition 8 | — | — | Citric | 0.2 | 2.16 |
| | | | acid | | |
| Composition 9 | Dodecyl benzene | 500 | Citric | 2.5 | 1.30 |
| | sulfonic acid | | acid | | |
| Composition 10 | Sodium dodecyl | 200 | — | — | 7.10 |
| | benzene sulfonate | | | | |

TABLE 2

| | | | Evaluation | |
|---|---|---|---|---|
| | Cleaning agent | Cleaning | Clean- | Corrosion |
| | for alloy | temperature | liness | suppression |
| Example 1 | Composition 1 | 40° C. | A | A |
| Example 2 | Composition 2 | 40° C. | A | A |
| Example 3 | Composition 3 | 40° C. | B | A |
| Example 4 | Composition 4 | 40° C. | A | A |
| Example 5 | Composition 5 | 40° C. | A | B |
| Example 6 | Composition 6 | 40° C. | A | B |
| Example 7 | Composition 7 | 40° C. | B | B |
| Comparative | Composition 8 | 40° C. | C | B |
| Example 1 | | | | |
| Comparative | Composition 9 | 40° C. | A | C |
| Example 2 | | | | |
| Comparative | Composition 10 | 40° C. | C | A |
| Example 3 | | | | |

As shown in Table 2, all of the evaluation results of Examples 1 to 7 were “A” or “B”. On the other hand, in the Comparative Examples 1 to 3, the evaluation results for either of the cleanliness or the corrosion suppression were “C”, which were inferior evaluation results to those of Examples 1 to 7.

### Influence of Cleaning Temperature

The alloy material was produced using the cleaning agent for alloy material having the composition 2 at varied cleaning temperatures and evaluated for the cleanliness and the corrosion suppression. At cleaning temperatures from room temperature to 60° C., all the evaluations for the cleanliness and the corrosion suppression were the same as those of Example 2. On the other hand, at cleaning temperatures above 60° C., the evaluation results for the corrosion suppression tended to be inferior to that of Example 2. Accordingly, the cleaning temperature in the cleaning step is advantageously set at 60° C. or below.

1. A cleaning agent for alloy material, comprising an anionic surfactant having an SO₃M group (where M represents a counter ion), wherein the cleaning agent for alloy material has a pH in a range between 1.5 and 4, inclusive.

2. The cleaning agent for alloy material according to claim 1, further comprising an organic acid.

3. A method for producing an alloy material, comprising a cleaning step for cleaning an alloy material using the cleaning agent for alloy material according to claim 1.

4. The method for producing an alloy material according to claim 3, wherein the cleaning agent for alloy material has a temperature of 60° C. or below in the cleaning step.

5. The method for producing an alloy material according to claim 3, further comprising a polishing step performed prior to the cleaning step, wherein the alloy material is polished using a polishing composition in the polishing step.

6. The method for producing an alloy material according to claim 5, wherein in the cleaning step, the alloy material and the cleaning agent for alloy material are brought into contact with each other before the polishing composition attached to the alloy material in the polishing step is dried.
